(19) United States
(12) Patent Application Publication
(10) Pub. No.: US 2013/0286479 A1
(43) Pub. Date: Oct. 31, 2013

(54) Polarization recycling structure

(71) Applicants: Tze-Yun Sung, Taipei (TW); Shin-Gwo Shiue, Taipei (TW); Sing Wu, Taipei (TW); Ping-Jung Liu, Taipei (TW)

(72) Inventors: Tze-Yun Sung, Taipei (TW); Shin-Gwo Shiue, Taipei (TW); Sing Wu, Taipei (TW); Ping-Jung Liu, Taipei (TW)

(73) Assignee: Ko, Chi-Yuan of Cordic Technology Co. Ltd.

(21) Appl. No.: 13/455,153

(22) Filed: Apr. 25, 2012

(51) Int. Cl. G02B 27/28

(52) U.S. Cl. 359/492.01

(57) ABSTRACT

A polarization recycling structure that can recycle polarized light efficiently; according to its technical means, said polarization recycling structure is provided with an incident end enabling incident of unpolarized light and an outgoing end enabling radiation of vertical polarized light; it comprises: a first optical structure set adjacent to the incident end, a second optical structure adjacent to the outgoing end and a main gap set between the first and second optical structures; it is characterized by that: said first optical structure comprises of a first lens array and a first polarized grating that are arranged from the adjacent incident end to the main gap; said second optical structure comprises of a second polarized grating, a secondary gap, a louvered multi-twist retarder and a second lens array that are arranged from the adjacent main gap to the outgoing end.

### BACKGROUND OF INVENTION

1. Field of the Invention

The present invention relates generally to a polarization recycling structure.

2. Description of Related Art

Owing to the inherent restriction of LCD panel, the common LCD projector system could only use a kind of polarized light (e.g.: S-polarized light) at a certain direction, rather than the polarized light (e.g.: parallel polarized light) in orthogonal directions, so half of the energy will be wasted.

In order to improve the efficiency of the LCD projector, a polarization recycling structure[i.e.: a structure used to convert the polarized light unavailable for the projector system into available polarized light] has been a main issue which is generally composed of LCD gratings in conjunction with lens arrays; FIG. 1 depicts the schematic view of a conventional polarization recycling structure (20)0, which comprises a first conventional lens array (A), a conventional polarized grating (B), a gap (X), a conventional louvered multi-twist retarder (C) and a second conventional lens array (D) arranged in sequence.

When the conventional unpolarized light (L1) is radiated into the conventional polarization recycling structure (20)0, it will enter into the conventional polarized grating (B) through the first conventional lens array (A), then it is split into left handed circularly polarized light (L2) and right handed circularly polarized light (L3).

In such case, the left handed circularly polarized light (L2) and right handed circularly polarized light (L3) will be converted into the first S-polarized light (L4) and second S-polarized light (L5) through the conventional louvered multi-twist retarder (C), and then output to the projector system through the second conventional lens array (D).

Beam splitting may occur after the conventional unpolarized light (L1) permeates through the conventional polarized grating (B), so the first S-polarized light (L4) and second S-polarized light (L5) will generate error, making it impossible for the optical system to utilize efficiently the first S-polarized light (L4) and second S-polarized light (L5).

For this reason, the primary objective of the present invention is focused on how to improve the polarization recycling structure and convert efficiently the polarized light for enhanced overall performance of the projector system.

### SUMMARY OF THE INVENTION

The present invention provides a polarization recycling structure that can recycle efficiently the polarized light. It can be implemented by the following four technical means:

According to the first technical means, the improved polarization recycling structure comprising:

a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first lens array (11) and a first polarized grating (12) that are arranged from the adjacent incident end (IN) to the main gap (H1);

said second optical structure 2 comprises of a second polarized grating (21), a secondary gap (H2), a louvered multi-twist retarder (22) and a second lens array (23) that are arranged from the adjacent main gap (H1) to the outgoing end (OUT).

According to the second technical means, the improved polarization recycling structure comprising:

a polarization recycling structure (100), which is provided with an incident end (IN) enabling incident of unpolarized light 10 and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first lens array (11) and a first polarized grating (12) that are arranged from the adjacent incident end (IN) to the main gap (H1);

said second optical structure 2 comprises of a second lens array (23), a second polarized grating (21), a secondary gap (H2) and a louvered multi-twist retarder (22) that are arranged from the adjacent main gap (H1) to the outgoing end (OUT).

According to the third technical means, the improved polarization recycling structure comprising:

a polarization recycling structure (100), which is provided with an incident end (IN) enabling incident of unpolarized light 10 and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first polarized grating (12) and a first lens array (11) that are arranged from the adjacent incident end (IN) to the main gap (H1);

said second optical structure 2 comprises of a second polarized grating (21), a secondary gap (H2), a louvered multi-twist retarder (22) and a second lens array (23) that are arranged from the adjacent main gap (H1) to the outgoing end (OUT).

According to the fourth technical means, the improved polarization recycling structure comprising:

a polarization recycling structure (100), which is provided with an incident end (IN) enabling incident of unpolarized light 10 and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first polarized grating (12) and a first lens array (11) that are arranged from the adjacent incident end (IN) to the main gap (H1);

said second optical structure 2 comprises of a second lens array (23), a second polarized grating (21), a secondary gap (H2) and a louvered multi-twist retarder (22) that are arranged from the adjacent main gap (H1) to the outgoing end (OUT).

As for the improved polarization recycling structure in the aforementioned technical means, said first lens array (11) is provided with a convex surface adjacent to the incident end (IN) and a flat surface far away from the incident end (IN); said second lens array (23) is provided with a flat surface adjacent to the main gap (H1) and a convex surface far away from the main gap (H1).

### BRIEF DESCRIPTION OF THE DRAWINGS

FIG. 1: A schematic view of conventional polarization recycling structure.

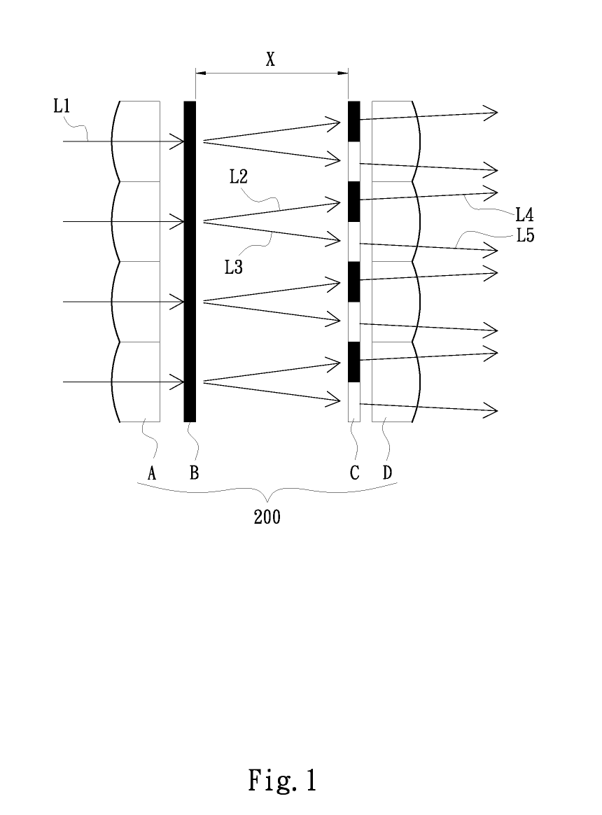

FIG. 2: A schematic view of the first preferred embodiment of the polarization recycling structure of the utility model.

FIG. 3: A schematic view of the second preferred embodiment of the polarization recycling structure of the utility model.

FIG. 4: A schematic view of the third preferred embodiment of the polarization recycling structure of the utility model.

FIG. 5: A schematic view of the fourth preferred embodiment of the polarization recycling structure of the utility model.

### DETAILED DESCRIPTION OF THE INVENTION

The preferred embodiments are described hereunder with reference to the accompanying drawings:

### Preferred Embodiment 1

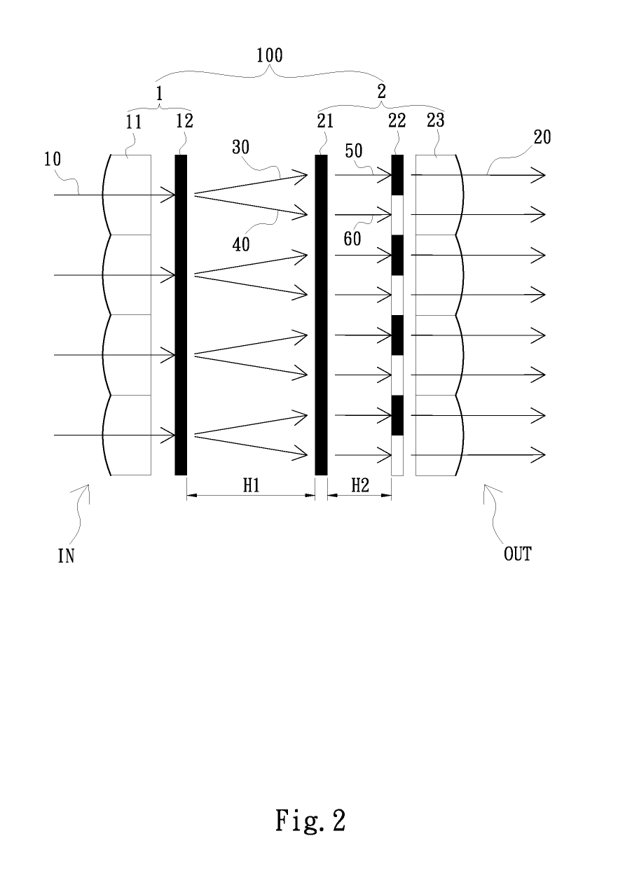

FIG. 2 is a schematic view of the first preferred embodiment of the polarization recycling structure of the present invention, wherein a polarization recycling structure comprising:

a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first lens array (11) and a first polarized grating (12) that are arranged from the adjacent incident end (IN) to the main gap (H1);

said second optical structure 2 comprises of a second polarized grating (21), a secondary gap (H2), a louvered multi-twist retarder (22) and a second lens array (23) that are arranged from the adjacent main gap (H1) to the outgoing end (OUT).

Of which, the polarization process of the first preferred embodiment is as follows:

[1] when the unpolarized light (10) is radiated into the first polarized grating (12) through the first lens array (11), it is split into left handed circularly polarized light (30) and right handed circularly polarized light (40);

[2] after the first left handed circularly polarized light (30) permeates the second polarized grating (21), its outgoing end will be converged, so the light will be converted into the second right handed circularly polarized light (50), then into a vertical polarized light (20) through the corresponding louvered multi-twist retarder (22), and output to the projector system through the second lens array (23);

[3] after the first right handed circularly polarized light (40) permeates the second polarized grating (21), its outgoing end will be converged, so the light will be converted into the second left handed circularly polarized light (60), then into a vertical polarized light (20) through the corresponding louvered multi-twist retarder (22), and output to the projector system through the second lens array (23).

### Preferred Embodiment 2

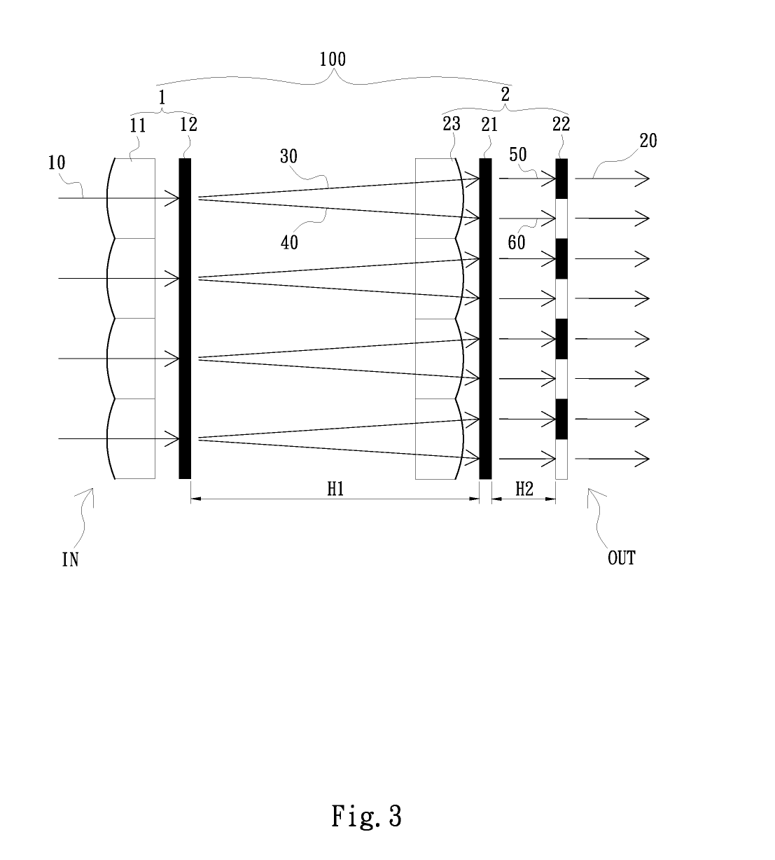

FIG. 3 is a schematic view of the second preferred embodiment of the polarization recycling structure of the present invention, wherein a polarization recycling structure comprising:

a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first lens array (11) and a first polarized grating (12) that are arranged from the adjacent incident end (IN) to the main gap (H1);

said second optical structure 2 comprises of a second lens array (23), a second polarized grating (21), a secondary gap (H2) and a louvered multi-twist retarder (22) that are arranged from the adjacent main gap (H1) to the outgoing end (OUT).

Of which, the polarization process of the second preferred embodiment is as follows:

[1] when the unpolarized light (10) is radiated into the first polarized grating (12) through the first lens array (11), it is split into left handed circularly polarized light (30) and right handed circularly polarized light (40);

[2] after the first left handed circularly polarized light (30) is radiated into the second polarized grating (21) through the second lens array (23), its outgoing end will be converged, so the light will be converted into the second right handed circularly polarized light (50), then into a vertical polarized light (20) through the corresponding louvered multi-twist retarder (22), and output to the projector system;

[3] after the first right handed circularly polarized light (40) is radiated into the second polarized grating (21) through the second lens array (23), its outgoing end will be converged, so the light will be converted into the second left handed circularly polarized light (60), then into a vertical polarized light (20) through the corresponding louvered multi-twist retarder (22), and output to the projector system.

### Preferred Embodiment 3

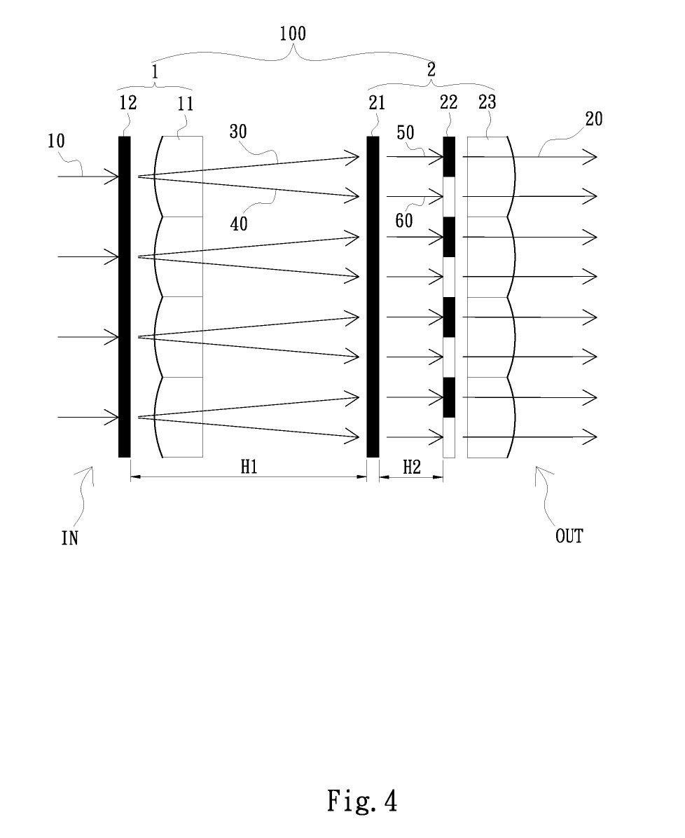

FIG. 4 is a schematic view of the third preferred embodiment of the polarization recycling structure of the present invention, wherein a polarization recycling structure comprising:

a polarization recycling structure (100), which is provided with an incident end (IN) enabling incident of unpolarized light 10 and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first polarized grating (12) and a first lens array (11) that are arranged from the adjacent incident end (IN) to the main gap (H1);

said second optical structure 2 comprises of a second polarized grating (21), a secondary gap (H2), a louvered multi-twist retarder (22) and a second lens array (23) that are arranged from the adjacent main gap (H1) to the outgoing end (OUT).

Of which, the polarization process of the third preferred embodiment is as follows:

[1] when the unpolarized light 10 is radiated into the first polarized grating (12), it is split into left handed circularly polarized light (30) and right handed circularly polarized light (40);

[2] after the first left handed circularly polarized light (30) is radiated into the second polarized grating (21) through the first lens array (11), its outgoing end will be converged, so the light will be converted into the second right handed circularly polarized light (50), then into a vertical polarized light (20) through the corresponding louvered multi-twist retarder (22), and output to the projector system through the second lens array (23);

[3] after the first right handed circularly polarized light (40) is radiated into the second polarized grating (21) through the first lens array (11), its outgoing end will be converged, so the light will be converted into the second left handed circularly polarized light (60), then into a vertical polarized light (20) through the corresponding louvered multi-twist retarder (22), and output to the projector system through the second lens array (23).

### Preferred Embodiment 4

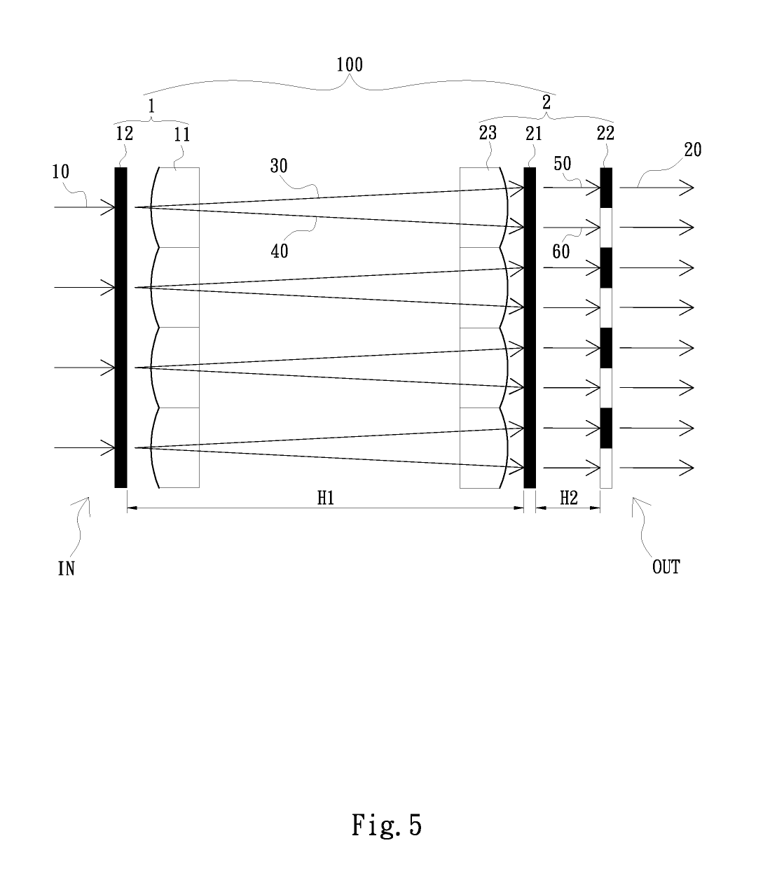

FIG. 5 is a schematic view of the fourth preferred embodiment of the polarization recycling structure of the present invention, wherein a polarization recycling structure comprising:

a polarization recycling structure (100), which is provided with an incident end (IN) enabling incident of unpolarized light 10 and an outgoing end (OUT) enabling radiation of vertical polarized light (20); the polarization recycling structure (100) comprises: a first optical structure 1 set adjacent to the incident end (IN), a second optical structure 2 adjacent to the outgoing end (OUT) and a main gap (H1) set between the first and second optical structures 1, 2;

it is characterized by that:

said first optical structure 1 comprises of a first polarized grating (12) and a first lens array (11) that are arranged from the adjacent incident end (IN) to the main gap (H1);

said second optical structure 2 comprises of a second lens array (23), a second polarized grating (21), a secondary gap (H2) and a louvered multi-twist retarder (22) that are arranged from the adjacent main gap (H1) to the outgoing end (OUT).

Of which, the polarization process of the fourth preferred embodiment is as follows:

[1] when the unpolarized light (10) is radiated into the first polarized grating (12), it is split into left handed circularly polarized light (30) and right handed circularly polarized light (40);

[2] after the first left handed circularly polarized light (30) is radiated into the second polarized grating (21) through the first and second lens array (11), (23), its outgoing end will be converged, so the light will be converted into the second right handed circularly polarized light (50), then into a vertical polarized light (20) through the corresponding louvered multi-twist retarder (22), and output to the projector system;

[3] after the first right handed circularly polarized light (40) is radiated into the second polarized grating (21) through the first and second lens array (11), (23), its outgoing end will be converged, so the light will be converted into the second left handed circularly polarized light (60), then into a vertical polarized light (20) through the corresponding louvered multi-twist retarder (22), and output to the projector system.

In the aforementioned four preferred embodiments, the first and second lens array (11), (23) enable homogenization of parallel optical sources;

with the first polarized grating (12), the incident unpolarized light (10) is split into the first left handed circularly and first right handed circularly polarized lights (30), (40);

with the second polarized grating (21), the outgoing angle of the incident left handed circularly and right handed circularly polarized lights (30), (40) will be converged, so the lights are converted into the second left handed circularly and second right handed circularly polarized lights (50), (60);

the louvered multi-twist retarder (22) is composed of orthogonal quarter wave plates in the fast axis [F-axis] direction, which could convert the incident second left handed circularly and second right handed circularly polarized lights (50), (60) into linearly vertical polarized light (20).

With these implementation methods, the vertical polarized light (20) could be utilized by the optical system, so as to improve the overall efficiency of the projector system while addressing the problem in utilization of vertical polarized light (20).

In the aforementioned four preferred embodiments, said first lens array (11) is provided with a convex surface adjacent to the incident end (IN) and a flat surface far away from the incident end (IN);

said second lens array (23) is provided with a flat surface adjacent to the main gap (H1) and a convex surface far away from the main gap (H1).

Through the aforementioned configuration mode of the first and second lens array (11), (23), homogenized optical sources could be used more efficiently.

It is worthy to note that, the configuration of major components in the four preferred embodiments is different, so the utility model can be adapted to different projector system for enhanced applicability.

Furthermore, the polarization recycling structure (100) can recycle polarized light more efficiently to avoid incomplete polarization with the setting of the first polarized grating (12), second polarized grating (21) and louvered multi-twist retarder (22).

The following efficacies can be realized with the implementation of the present invention:

1. with the setting of the first and second optical structures 1, 2, the polarized light can be converted more efficiently, so that the vertical polarized light (20) could be used by optical system to improve the overall efficiency of the projector system while addressing the problem in utilization of vertical polarized light (20);

2. with different combinations of the first and second optical structures 1, 2, the owner has more options to use the projector system for improved industrial applicability and universality.

Although the invention has been explained in relation to its preferred embodiment, it is to be understood that many other possible modifications and variations can be made without departing from the spirit and scope of the invention as hereinafter claimed.

1. A polarization recycling structure, which comprising:
a polarization recycling structure (100), which is provided with an incident end enabling incident (IN) of unpolarized light (10) and an outgoing end (OUT) enabling radiation of vertical polarized light (20); the polarization recycling structure comprises: a first optical structure (1) set adjacent to the incident end (IN), a second optical structure (2) adjacent to the outgoing end (OUT) and a main gap (H1) set between the first and second optical structures;
it is characterized by that:
said first optical structure (1) comprises of a first lens array (11) and a first polarized grating (12) that are arranged from the adjacent incident end (IN) to the main gap (H1);
said second optical structure (2) comprises of a second polarized grating (21), a secondary gap (H2), a louvered multi-twist retarder (22) and a second lens array (23) that are arranged from the adjacent main gap (H1) to the outgoing end (OUT).

2. The structure defined in claim 1, wherein said first lens array (11) is provided with a convex surface adjacent to the incident end (IN) and a flat surface far away from the incident end (IN);
said second lens (23) array is provided with a flat surface adjacent to the main gap (H1) and a convex surface far away from the main gap (H1).

3. A polarization recycling structure, which comprising:
a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure (1) set adjacent to the incident end (IN), a second optical structure (2) adjacent to the outgoing end (OUT) and a main gap (H1) set between the first and second optical structures;
it is characterized by that:
said first optical structure (1) comprises of a first lens array (11) and a first polarized grating (12) that are arranged from the adjacent incident end (IN) to the main gap (H1);
said second optical structure (2) comprises of a second lens array (23), a second polarized grating (21), a secondary gap (H2) and a louvered multi-twist retarder (22) that are arranged from the adjacent main gap (H1) to the outgoing end (OUT).

4. The structure defined in claim 3, wherein said first lens array (11) is provided with a convex surface adjacent to the incident end (IN) and a flat surface far away from the incident end (IN);
said second lens array (23) is provided with a flat surface adjacent to the main gap (H1) and a convex surface far away from the main gap (H1).

5. A polarization recycling structure, which comprising:
a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure (1) set adjacent to the incident end (IN), a second optical structure (2) adjacent to the outgoing end (OUT) and a main gap (H1) set between the first and second optical structures;
it is characterized by that:
said first optical structure (1) comprises of a first polarized grating (12) and a first lens array (11) that are arranged from the adjacent incident end (IN) to the main gap (H1);
said second optical structure (2) comprises of a second polarized grating (21), a secondary gap (H2), a louvered multi-twist retarder (22) and a second lens array (23) that are arranged from the adjacent main gap (H1) to the outgoing end (OUT).

6. The structure defined in claim 5, wherein said first lens array (11) is provided with a convex surface adjacent to the incident end (IN) and a flat surface far away from the incident end (IN);
said second lens array (23) is provided with a flat surface adjacent to the main gap (H1) and a convex surface far away from the main gap (H1).

7. A polarization recycling structure, which comprising:
a polarization recycling structure (100), which is provided with an incident end (IN) enabling incident of unpolarized light (10) and an outgoing end (OUT) enabling radiation of vertical polarized light (20); the polarization recycling structure (100) comprises: a first optical structure (1) set adjacent to the incident end (IN), a second optical structure (2) adjacent to the outgoing end (OUT) and a main gap (H1) set between the first and second optical structures;
it is characterized by that:
said first optical structure (1) comprises of a first polarized grating (12) and a first lens array (11) that are arranged from the adjacent incident end (IN) to the main gap (H1);
said second optical structure (2) comprises of a second lens array (23), a second polarized grating (21), a secondary gap and a louvered multi-twist retarder (22) that are arranged from the adjacent main gap (H1) to the outgoing end (OUT).

8. The structure defined in claim 7, wherein said first lens array (11) is provided with a convex surface adjacent to the incident end (IN) and a flat surface far away from the incident end (IN);
said second lens array (23) is provided with a flat surface adjacent to the main gap (H1) and a convex surface far away from the main gap (H1).
